(19) United States
(12) Patent Application Publication
(10) Pub. No.: US 2012/0087420 A1
(43) Pub. Date: Apr. 12, 2012

(54) Data Interface Apparatus Having Adaptive Delay Control Function

(75) Inventor: Eung Ju Kim, Seoul (KR)

(73) Assignee: SAMSUNG ELECTRO-MECHANICS CO., LTD., Gyunggi-do (KR)

(21) Appl. No.: 13/216,043

(22) Filed: Aug. 23, 2011

(30) Foreign Application Priority Data
Oct. 6, 2010 (KR) 1020100097469

(51) Int. Cl. H04L 27/00

(52) U.S. Cl. 375/259

(57) ABSTRACT

Disclosed herein is a data interface apparatus having an adaptive delay control function, which includes a transmitter generating and transmitting data and strobe signals through an intermediate signal path; and a receiver restoring data by receiving the signals, detecting a time difference of a low-level signal and a high-level signal of a strobe signal after an interval where data is high and strobe is low, regulating skew according to the detected time difference, and outputting the strobe signal with the regulated skew. Hence, the skew can be actively regulated in an environment where the skew changes.

### CROSS REFERENCE TO RELATED APPLICATION

This application claims the benefit of Korean Patent Application No. 10-2010-0097469, filed on Oct. 6, 2010, entitled “Data Interface Apparatus Having Adaptive Delay Control Function” which is hereby incorporated by reference in its entirety into this application.

### BACKGROUND OF THE INVENTION

1. Technical Field

The present invention relates to a data interface apparatus having an adaptive delay control function.

2. Description of the Related Art

To transfer high-speed data from a host, which is a transmitter of a mobile device, to a client, which is a receiver, it is necessary to send a clock together with the data. In this regard, a Mobile Digital Display Interface (MDDI) device encodes and transmits the data and the clock as a strobe signal using an Exclusive OR (XOR) circuit.

As such, when the MDDI device encodes and transmits the data and the clock as the strobe signal, validity of the transmitted clock can be increased.

However, physical mismatch exists between a logical circuit and a register used in the MDDI device, and an interface. When the receiver restores the clock, frequency and duty ratio of the restored clock are not consistent, that is, skew occurs.

To address those problems, the prior art matches the physical interface of two signals by inserting a delay cell to a data line of the receiver so as to reduce the skew of the data and the strobe.

Advantageously, this method can regulate the skew by simply inserting the delay cell. However, as the inserted delay cell provides the fixed delay value, when the amount of the skew changes according to time or situation, it is difficult to reflect the change.

### SUMMARY OF THE INVENTION

The present invention has been made in an effort to provide a data interface apparatus having an adaptive delay control function for detecting a time difference of a low-level signal to and a high-level signal of a strobe signal after an interval where data is high and the strobe is low, and thus regulating skew according to the detected time difference.

According to a preferred embodiment of the present invention, there is provided a data interface apparatus having an adaptive delay control function including: a transmitter generating and transmitting data and strobe signals through an intermediate signal path; and a receiver restoring data by receiving the signals, detecting a time difference of a low-level signal and a high-level signal of a strobe signal after an interval where data is high and strobe is low, regulating the skew according to the detected time difference, and outputting the strobe signal with the regulated skew.

The transmitter may include a first flip-flop having a data terminal connected to an input data terminal and using a clock signal as a trigger signal; a second flip-flop using the clock signal as a trigger signal; an exclusive NOR gate circuit providing an output signal generated by receiving output and input data of the first flip-flop and output of the second flip-flop and performing an exclusive NOR processing thereon, to a data terminal of the second flip-flop as input; a first differential line driver having an input terminal connected to an output terminal of the first flip-flop; and a second differential line driver having an input terminal connected to an output terminal of the second flip-flop.

The receiver may include a skew regulator receiving a restored clock signal, detecting the time difference of the low-level signal and the high-level signal of the strobe signal after the interval where the data is high and the strobe is low by receiving the data signal and the strobe signal sent from the transmitter, regulating the skew according to the detected time difference, and outputting the strobe signal with the regulated skew.

The receiver may include a first differential line receiver receiving the data signal of the transmitter; a second differential line receiver receiving the strobe signal of the transmitter; a skew regulator receiving a restored clock signal, receiving the data signal output from the first differential line receiver, receiving the strobe signal output from the second differential line receiver, detecting the time difference of the low-level signal and the high-level signal of the strobe signal after the interval where the data is high and the strobe is low, regulating the skew according to the detected time difference, and outputting the strobe signal with the regulated skew; a third flip-flop having a data terminal connected to an output terminal of the first differential line receiver, generating and outputting a data signal using the restored clock signal as a trigger signal; a fourth flip-flop having a data terminal connected to the output terminal of the first differential line receiver, generating and outputting an inverted data signal using the restored clock signal as a trigger signal; and an exclusive OR gate circuit restoring the clock signal by receiving data output of the first differential line receiver and strobe output of the skew regulator, and providing the restored clock signal to the skew regulator and the third and fourth flip-flops.

The skew regulator may include a fifth flip-flop outputting a determination interval signal which informs of a start and an end of one cycle interval of the restored clock signal using the strobe signal as a data input and the data signal as a trigger signal; a rising edge detector receiving the restored clock signal, detecting and outputting a rising edge; a sixth flip-flop generating and outputting a pull-up signal when the strobe signal is at a high level in a determination interval by using the determination interval signal of the fifth flip-flop as a data input and output of the first rising edge detector as a trigger signal; a seventh flip-flop outputting a pull-down signal when the strobe signal is at a low level by using the strobe signal as a data input and the determination interval signal of the first flip-flop as a trigger signal; a first falling edge detector receiving the restored clock signal, detecting and outputting a falling edge; a second falling edge detector receiving the pull-up signal of the sixth flip-flop, detecting and outputting a falling edge; a charge pump outputting a voltage control delay signal by receiving the pull-up signal output from the sixth flip-flop and receiving the pull-down signal output from the seventh flip-flop; and a voltage control delay block regulating and outputting delay of the strobe signal by receiving the strobe signal and the voltage control delay signal corresponding to the difference of the time difference of the low-level signal and the high-level signal output from the charge pump.

The charge pump may include a pull-up transistor connected between a power supply and an output terminal, and receiving a pull-up control signal as a gate input; a pull-down transistor connected between a ground source and the output terminal, and receiving a pull-down control signal as a gate input; and a load capacitor connected to an output terminal of the pull-up transistor and an input terminal of the pull-down transistor in parallel, outputting a charge voltage according to charge and discharge of electric charge, as the voltage control delay signal.

The voltage control delay block may include a first input PMOS transistor having a source connected to a power source and using the strobe signal as a gate signal; a second input PMOS transistor having a source connected to the power source and using the strobe inverse signal as a gate signal; a first NMOS transistor having a gate connected to the output of the charge pump, and receiving the voltage control delay signal; a second NMOS transistor having a gate connected to the output of the charge pump, and inverting and receiving the voltage control delay signal; a first NMOS load chain transistor having a drain coupled to a drain of the first input PMOS transistor and a drain of the first NMOS transistor; and a second NMOS load chain transistor having a drain coupled to the drain of the second PMOS transistor and the drain of the second NMOS transistor, and having a gate coupled to the first NMOS load chain transistor.

### BRIEF DESCRIPTION OF THE DRAWINGS

FIG. 1 is a diagram of a data interface apparatus having an adaptive delay control function according to a preferred embodiment of the present invention;

FIG. 2 is a detailed block diagram of a skew regulator of FIG. 1;

FIG. 3 is a diagram of a strobe signal, a data signal, a clock signal, a determination interval signal, a voltage control delay signal, a pull-up signal, and a pull-down signal used in the present invention;

FIG. 4 is a detailed block diagram of a charge pump of FIG. 2;

FIG. 5 is a diagram of a signal generated by the charge pump of FIG. 4; and

FIG. 6 is an internal diagram of a voltage control delay block of FIG. 2.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

FIG. 1 is a diagram of a data interface apparatus having an adaptive delay control function according to a preferred embodiment of the present invention.

Referring to FIG. 1, the data interface apparatus having the adaptive delay control function according to a preferred embodiment of the present invention includes a transmitter 100 generating and transmitting original DATA and strobe (STB) signals through an intermediate signal path 102, and a receiver 120 receiving the signals and restoring to data.

Herein, the transmitter 100 includes a first flip-flop 104 having a data terminal connected to an input data terminal and using a clock signal as a trigger signal, a 3-input exclusive NOR gate circuit 112 receiving the output and input data of the first flip-flop 104, and output of a second flip-flop 106, the second flip-flop 106 having a data terminal connected to an output terminal of the exclusive NOR gate circuit 112 and using the clock signal as a trigger signal, a first differential line driver 108 having an input terminal connected to the output terminal of the first flip-flop 104, and a second differential line driver 110 having an input terminal connected to the output terminal of the second flip-flop 106.

The receiver 120 includes a first differential line receiver 122 connected to the output terminal of the first differential line driver 108, a second differential line receiver 124 connected to the second differential line driver 110, a 2-input exclusive OR (XOR) gate circuit 126 receiving the output of the first differential line receiver 122 and the output of a skew regulator 132 as its input, a third flip-flop 128 having a data terminal connected to the output terminal of the first differential line receiver 122 and using the output of the exclusive OR gate circuit 126 as a trigger signal, a fourth flip-flop 130 having a data terminal connected to the output terminal of the first differential line receiver 122 and inverting and using the output of the exclusive OR gate circuit 126 as a trigger signal, and the skew regulator 132 connected to the output terminals of to the first and second differential line receivers 122 and 124 and the exclusive OR gate circuit 126.

To send data from the transmitter 100 to the receiver 120 as constructed above, the DATA signal is input to the two D flip-flops 104 and 106 together with the clock signal for triggering the circuits

The outputs Q of the two flip-flops 104 and 106 are divided and sent to different signal pairs MDDI_Data0+, MDDI_Data0−, MDDI_Stb+, and MDDI_Stb− by the two differential line drivers 108 and 110 (voltage mode).

The 3-input XNOR gate circuit 112 receives the DATA and the outputs of the two flip-flops 104 and 106, and generates the output for providing the data input for the second flip-flop circuit 106, which generates MDDI_Stb+ and MDDI_Stb− signals in order.

To simplify the understanding, the XNOR gate circuit 112 has an inversion mark placed to indicate that the output Q of the second flip-flop 106 generating the strobe is efficiently inverted.

Next, in the receiver 120, the signals MDDI_Data0+, MDDI_Data0−, MDDI_Stb+, and MDDI_Stb− are received by the two differential line receivers 122 and 124, respectively, and single ended outputs are generated from the differential signals.

The outputs of the differential line receivers 122 and 124 are input to the 2-input exclusive OR (XOR) gate circuit 126, which generates the clock signal.

At this time, the output signal of the second differential line receiver 124 reduces the skew through the skew regulator 132 and is input to the 2-input exclusive OR gate circuit 126.

Hence, the clock signal output from the 2-input exclusive OR gate circuit 126 becomes the clock signal with the reduced skew.

The XOR gate circuit 126 receives the DATA and STB signals and regenerates the clock using exclusive OR processing. The generated clock has a half cycle of the clock input to the transmitter 100.

Such a clock signal is used to trigger the two D flip-flop circuits 128 and 130 which receive the output of the first differential line receiver 122 as the data input.

The third flip-flop circuit 128 generates a data value ‘0’ by using the output of the first differential line receiver 122 as the data input and the output of the exclusive OR gate circuit 126 as the trigger signal.

The fourth flip-flop circuit 130 generates a data value ‘1’ by using the output of the first differential line receiver 122 as the data input, and inverting and using the output of the exclusive OR gate circuit 126 as the trigger signal.

Meanwhile, the skew regulator 132 detects a time difference of a low-level signal and a high-level signal per cycle interval of the clock signal output from the exclusive OR gate circuit 126 after the interval where the data is high and the strobe is low, regulates the skew according to the detected time difference, and thus outputs the strobe signal with the regulated skew.

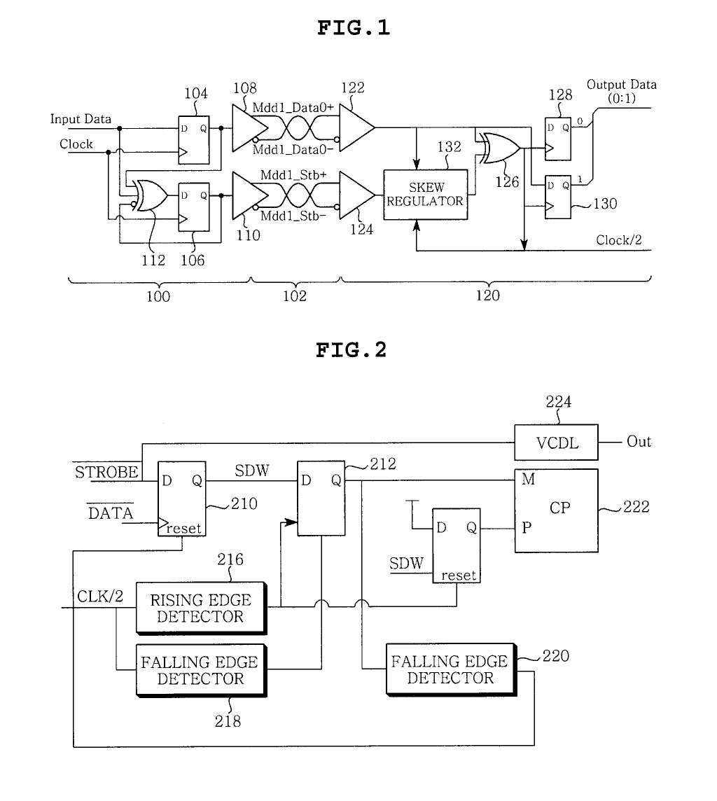

FIG. 2 is a detailed block diagram of the skew regulator of FIG. 1.

Referring to FIG. 2, the skew regulator of FIG. 1 includes three D flip-flops 210, 212, and 214, a rising edge detector 216, two falling edge detectors 218 and 220, a charge pump 222, and a voltage control delay block 224.

Using the strobe signal as the data input and the data signal as the trigger signal, the first flip-flop 210 outputs a determination interval signal SDW which informs of the start and the end of one cycle interval of the clock signal output from the exclusive OR gate circuit 126 after the interval where the data is high and the strobe is low.

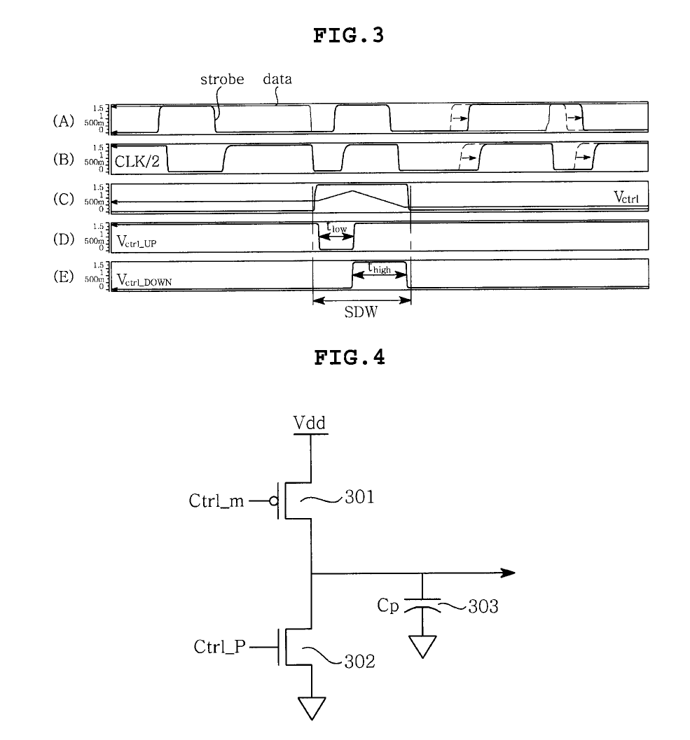

The signals used in the present invention (the strobe signal of FIG. 3A, the data signal of FIG. 3A, the clock signal of FIG. 3B, the determination interval signal of FIG. 3C, a voltage control delay signal of FIG. 3C, a pull-up signal of FIG. 3D, and a pull-down signal of FIG. 3E) are described by referring to FIG. 3. With the low-level strobe signal and the high-level data signal in FIG. 3A, when the data signal changes to the low level, the determination interval signal SDW changes from the low level to the high level signal to inform of the start of the determination interval as shown in FIG. 3C. When the clock signal of FIG. 3B changes from the high state to the low state, the determination interval signal SDW changes from the high state to the low state to inform of the end of the determination interval as shown in FIG. 3C.

The first flip-flop 210 is connected with a reset terminal to the output of the falling edge detector 220, which detects and outputs the falling edge of the output of the second flip-flop 212, and is reset when the signal of the second flip-flop 212 falls.

Next, using the determination interval signal of the first flip-flop 210 as the data input and the output of the first rising edge detector 216 as the trigger signal, the second flip-flop 212 generates and outputs the pull-up signal of FIG. 3D to the charge pump 222 when the strobe signal in the determination interval is at the high level. The second flip-flop 212 is connected with a reset terminal to the output of the falling edge detector 218, which detects and outputs the falling edge of the clock signal, and is reset when the clock signal falls.

Using the strobe signal as the data input and the output signal of the first flip-flop 210, that is, the determination interval signal as the trigger signal, the third flip-flop 214 generates and outputs a pull-down signal of FIG. 3E to the charge pump 222 when the strobe signal is at the low level. The third flip-flop 214 is connected with a reset terminal to the output of the falling edge detector 218, which detects and outputs the falling edge of the clock signal, and is reset when the clock signal falls.

Meanwhile, the first rising edge detector 216 receives the output of the exclusive OR gate circuit 126, detects and outputs the rising edge.

The first falling edge detector 218 receives the output of the exclusive OR gate circuit 126, detects and outputs the falling edge. The second falling edge detector 220 receives the pull-up signal of the second flip-flop 212, detects and outputs the falling edge.

Next, the charge pump 222 charges and discharges the electric charge by receiving the to pull-up signal output from the second flip-flop 212 and the pull-down signal output from the third flip-flop 214, and outputs a voltage control delay signal Vct1 according to the charge voltage as shown in FIG. 3C. At this time, the signal output from the charge pump 222 outputs the voltage corresponding to the difference according to the time difference of the low-level signal and the high-level signal.

The voltage control delay block 224 receives the strobe signal output from the second differential line receiver 122, receives a voltage control delay signal corresponding to the difference according to the time difference of the low-level signal and the high-level signal output from the charge pump 222, and thus regulates and outputs the delay of the strobe signal.

FIG. 4 is a detailed block diagram of the charge pump of FIG. 2.

Referring to FIG. 4, the charge pump of FIG. 2 includes a pull-up transistor 301 connected between a power supply VDD and the output terminal and receiving the pull-up control signal as the gate input, a pull-down transistor 302 connected between a ground source GND and the output terminal and receiving the pull-down control signal as the gate input, and a load capacitor 303 connected to the output terminal of the pull-up transistor 301 and the input terminal of the pull-down transistor 302 in parallel and outputting the charge voltage according to the charge and discharge of the electric charge as the voltage control delay signal.

While the pull-up transistor 301 and the pull-down transistor 302 in the charge pump are implemented using CMOS, they can be implemented using NMOS transistors in some cases.

In such a charge pump, the load capacitor 303 is charged while the pull-up control signal at the high level is applied to the pull-up transistor 301, and the load capacitor 303 is discharged while the pull-down control signal is applied to the pull-down transistor 302. When the applying time of the pull-up control signal and the applying time of the pull-down control signal are different from each other, the corresponding voltage difference is reflected and output as the charge voltage. Hence, the voltage reflecting the difference according to the time difference of the low-level signal and the high-level signal is output as the voltage control delay signal.

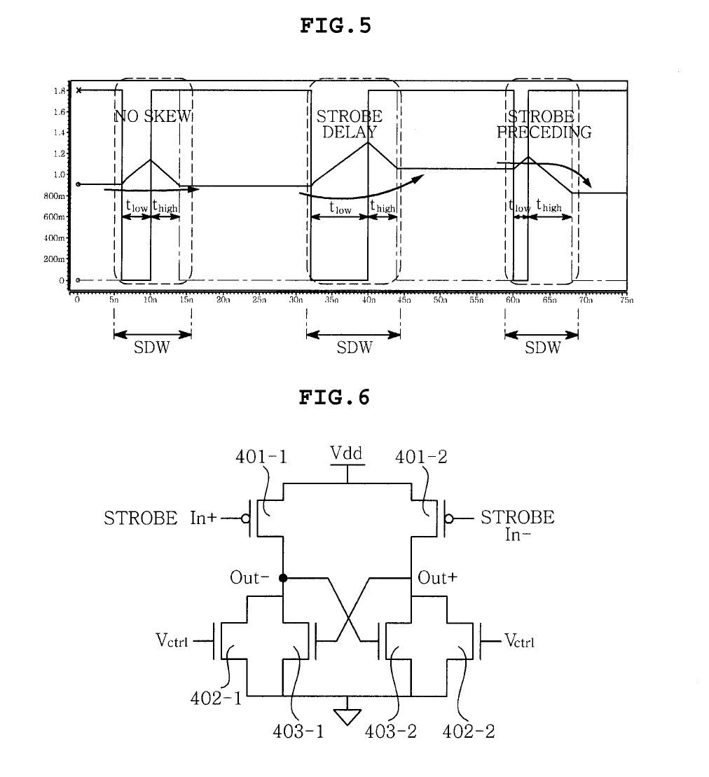

Referring to FIG. 5 showing the voltage control delay signal in each skew condition, when the skew does not occur in the receiver, the time for turning on the pull-up transistor 301 and the time for turning on the pull-down transistor 302 are the same and the voltage control delay signal does not change at all even after passing through the determination interval.

However, when the skew with the delayed strobe occurs in the receiver, the time for turning on the pull-up transistor 301 is longer than the time for turning on the pull-down transistor 302 and thus the voltage control delay signal increased from the previous determination interval is maintained than as shown in FIG. 5.

Conversely, when the skew with the preceding strobe occurs in the receiver, the time for turning on the pull-up transistor 301 is shorter than the time for turning on the pull-down transistor 302 and thus the voltage control delay signal smaller than the previous determination interval in the size is maintained as shown in FIG. 5.

FIG. 6 is an internal diagram of the voltage control delay block of FIG. 2.

As shown in FIG. 6, the voltage control delay block of FIG. 2 includes a first input PMOS transistor 401-1 having the gate receiving the strobe signal, the source connected to the reference voltage Vdd, and the drain connected to the output terminal, and a second input PMOS transistor 401-2 having the gate receiving the strobe inverse signal, the source connected to the reference voltage Vdd, and the drain connected to the output terminal.

The voltage control delay block also includes a first NMOS transistor 402-1 having the gate connected to the output of the charge pump and receiving the voltage control delay signal, and the drain connected to the drain of the first input PMOS transistor 401-1 and to the output terminal, and a second NMOS transistor 402-2 having the gate connected to the output of the charge pump and inverting and receiving the voltage control delay signal, and the drain connected to the second input PMOS transistor 401-2 and to the output terminal.

The voltage control delay block includes a load chain. Herein, the load chain includes a pair of transistors having opposite polarity to the input transistors.

The load chain transistors include a first NMOS load chain transistor 403-1 and a second NMOS load chain transistor 403-2.

The drain of the first NMOS load chain transistor 403-1 is connected to the drain of the first PMOS transistor 401-1, the gate of the second NMOS load chain transistor 403-2, and the drain and the output terminal of the first NMOS transistor 402-1. Next, the drain of the second NMOS load chain transistor 403-2 is connected to the drain of the second PMOS transistor 401-2, the gate of the first NMOS load chain transistor 403-1, and the input and output terminals of the second NMOS transistor 402-2. That is, the first NMOS load chain transistor 403-1 and the second NMOS load chain transistor 403-2 are cross coupled.

The voltage control delay block constructed as above receives the strobe signal at the first input PMOS transistor 401-1 and the strobe inverse signal at the second input PMOS transistor 401-2. When the skew occurs according to the voltage control delay signal at the low stage including the first NMOS transistor 402-1, the second NMOS transistor 402-2, the first load chain transistor 403-1, and the second load chain transistor 403-2, the voltage control delay block regulates and outputs the skew by delaying or preceding the strobe signal.

According to the present invention as explained above, when the amount of skew changes according to the time or the situation, the skew can be easily corrected by reflecting the change.

According to the present invention, by detecting the time difference of the low-level signal and the high-level signal of the strobe signal and regulating the skew according to the detected time difference, the skew can be regulated when the strobe signal is shorter than the data signal and vice versa.

Although the embodiments of the present invention regarding the touch panel have been disclosed for illustrative purposes, those skilled in the art will appreciate that a variety of different modifications, additions, and substitutions are possible, without departing from the scope and spirit of the invention as disclosed in the accompanying claims. Accordingly, such modifications, additions, and substitutions should also be understood as falling within the scope of the present invention.

What is claimed is:

1. A data interface apparatus having an adaptive delay control function, comprising:
a transmitter generating and transmitting data and strobe signals through an intermediate signal path; and
a receiver restoring data by receiving the signals, detecting a time difference of a low-level signal and a high-level signal of a strobe signal after an interval where data is high and strobe is low, regulating skew according to the detected time difference, and outputting the strobe signal with the regulated skew.

2. The data interface apparatus as set forth in claim 1, wherein the transmitter includes:
a first flip-flop connected to an input data terminal with a data terminal and using a clock signal as a trigger signal;
a second flip-flop using the clock signal as a trigger signal;
an exclusive NOR gate circuit providing an output signal generated by receiving output and input data of the first flip-flop and output of the second flip-flop and performing an exclusive NOR processing thereon, to a data terminal of the second flip-flop as input;
a first differential line driver having an input terminal connected to an output terminal of the first flip-flop; and
a second differential line driver having an input terminal connected to an output terminal of the second flip-flop.

3. The data interface apparatus as set forth in claim 1, wherein the receiver includes:
a skew regulator receiving a restored clock signal, detecting the time difference of the low-level signal and the high-level signal of the strobe signal after the interval where the data is high and the strobe is low by receiving the data signal and the strobe signal sent from the transmitter, regulating the skew according to the detected time difference, and outputting the strobe signal with the regulated skew.

4. The data interface apparatus as set forth in claim 1, wherein the receiver includes:
a first differential line receiver receiving the data signal of the transmitter;
a second differential line receiver receiving the strobe signal of the transmitter;
a skew regulator receiving a restored clock signal, receiving the data signal output from the first differential line receiver, receiving the strobe signal output from the second differential line receiver, detecting the time difference of the low-level signal and the high-level signal of the strobe signal after the interval where the data is high and the strobe is low, regulating the skew according to the detected time difference, and outputting the strobe signal with the regulated skew;
a third flip-flop having a data terminal connected to an output terminal of the first differential line receiver, generating and outputting a data signal using the restored clock signal as a trigger signal;
a fourth flip-flop having a data terminal connected to the output terminal of the first differential line receiver, generating and outputting an inverted data signal using the restored clock signal as a trigger signal; and
an exclusive OR gate circuit restoring the clock signal by receiving data output of the first differential line receiver and strobe output of the skew regulator, and providing the restored clock signal to the skew regulator and the third and fourth flip-flops.

5. The data interface apparatus as set forth in claim 3, wherein the skew regulator includes:
a fifth flip-flop outputting a determination interval signal, which informs of a start and an end of one cycle interval of the restored clock signal using the strobe signal as a data input and the data signal as a trigger signal;
a rising edge detector receiving the restored clock signal, detecting and outputting a rising edge;
a sixth flip-flop generating and outputting a pull-up signal when the strobe signal is at a high level in a determination interval by using the determination interval signal of the fifth flip-flop as a data input and output of the first rising edge detector as a trigger signal;
a seventh flip-flop outputting a pull-down signal when the strobe signal is at a low level by using the strobe signal as a data input and the determination interval signal of the first flip-flop as a trigger signal;
a first falling edge detector receiving the restored clock signal, detecting and outputting a falling edge;
a second falling edge detector receiving the pull-up signal of the sixth flip-flop, detecting and outputting a falling edge;
a charge pump outputting a voltage control delay signal by receiving the pull-up signal output from the sixth flip-flop and receiving the pull-down signal output from the seventh flip-flop; and
a voltage control delay block regulating and outputting delay of the strobe signal by receiving the strobe signal and the voltage control delay signal corresponding to the difference of the time difference of the low-level signal and the high-level signal output from the charge pump.

6. The data interface apparatus as set forth in claim 5, wherein the charge pump includes:
a pull-up transistor connected between a power supply and an output terminal, and receiving a pull-up control signal as a gate input;
a pull-down transistor connected between a ground source and the output terminal, and receiving a pull-down control signal as a gate input; and
a load capacitor connected to an output terminal of the pull-up transistor and an input terminal of the pull-down transistor in parallel, and outputting a charge voltage according to charge and discharge of electric charge, as the voltage control delay signal.

7. The data interface apparatus as set forth in claim 5, wherein the voltage control delay block includes:
to a first input PMOS transistor having a source connected to a power source and using the strobe signal as a gate signal;
a second input PMOS transistor having a source connected to the power source and using the strobe inverse signal as a gate signal;
a first NMOS transistor having a gate connected to the output of the charge pump, and receiving the voltage control delay signal;
a second NMOS transistor having a gate connected to the output of the charge pump, inverting and receiving the voltage control delay signal;
a first NMOS load chain transistor having a drain coupled to a drain of the first input PMOS transistor and a drain of the first NMOS transistor; and
a second NMOS load chain transistor having a drain coupled to the drain of the second PMOS transistor and the drain of the second NMOS transistor, and a gate coupled to the first NMOS load chain transistor.

8. The data interface apparatus as set forth in claim 4, wherein the skew regulator includes:
a fifth flip-flop outputting a determination interval signal, which informs of a start and an end of one cycle interval of the restored clock signal using the strobe signal as a data input and the data signal as a trigger signal;
a rising edge detector receiving the restored clock signal, detecting and outputting a rising edge;
a sixth flip-flop generating and outputting a pull-up signal when the strobe signal is at a high level in a determination interval by using the determination interval signal of the fifth flip-flop as a data input and output of the first rising edge detector as a trigger signal;
a seventh flip-flop outputting a pull-down signal when the strobe signal is at a low level by using the strobe signal as a data input and the determination interval signal of the first flip-flop as a trigger signal;
a first falling edge detector receiving the restored clock signal, detecting and outputting a falling edge;
a second falling edge detector receiving the pull-up signal of the sixth flip-flop, detecting and outputting a falling edge;
a charge pump outputting a voltage control delay signal by receiving the pull-up signal output from the sixth flip-flop and receiving the pull-down signal output from the seventh flip-flop; and
a voltage control delay block regulating and outputting delay of the strobe signal by receiving the strobe signal and the voltage control delay signal corresponding to the difference of the time difference of the low-level signal and the high-level signal output from the charge pump.

9. The data interface apparatus as set forth in claim 8, wherein the charge pump includes:
a pull-up transistor connected between a power supply and an output terminal, and receiving a pull-up control signal as a gate input;
a pull-down transistor connected between a ground source and the output terminal, and receiving a pull-down control signal as a gate input; and
a load capacitor connected to an output terminal of the pull-up transistor and an input terminal of the pull-down transistor in parallel, and outputting a charge voltage according to charge and discharge of electric charge, as the voltage control delay signal.

10. The data interface apparatus as set forth in claim 8, wherein the voltage control delay block includes:
to a first input PMOS transistor having a source connected to a power source and using the strobe signal as a gate signal;
a second input PMOS transistor having a source connected to the power source and using the strobe inverse signal as a gate signal;
a first NMOS transistor having a gate connected to the output of the charge pump, and receiving the voltage control delay signal;
a second NMOS transistor having a gate connected to the output of the charge pump, inverting and receiving the voltage control delay signal;
a first NMOS load chain transistor having a drain coupled to a drain of the first input PMOS transistor and a drain of the first NMOS transistor; and
a second NMOS load chain transistor having a drain coupled to the drain of the second PMOS transistor and the drain of the second NMOS transistor, and a gate coupled to the first NMOS load chain transistor.
